(19) United States
(12) Patent Application Publication
(10) Pub. No.: US 2025/0334779 A1
(43) Pub. Date: Oct. 30, 2025

(54) CAMERA MODULE

(71) Applicant: SAMSUNG ELECTRO-MECHANICS CO., LTD., Suwon-si (KR)

(72) Inventors: Sang Uk SON, Suwon-si (KR); Young Bok YOON, Suwon-si (KR)

(73) Assignee: SAMSUNG ELECTRO-MECHANICS CO., LTD., Suwon-si (KR)

(21) Appl. No.: 19/072,248

(22) Filed: Mar. 6, 2025

(30) Foreign Application Priority Data
Apr. 30, 2024 (KR) 10-2024-0057339
Aug. 21, 2024 (KR) 10-2024-0112239

(51) Int. Cl. G02B 13/00; G02B 7/10; G02B 27/64; G03B 5/00

(52) U.S. Cl. CPC G02B 13/0065; G02B 7/10; G02B 27/646; G03B 5/00; G03B 2205/0007; G03B 2205/0069

(57) ABSTRACT

A camera module is provided. The camera module includes a plurality of lens modules, each including one or more lenses; a reflective module including a reflective member configured to change a path of light incident on the plurality of lens modules, wherein the plurality of lens modules and the reflective module are disposed in a first optical axis direction, and one of the plurality of lens modules is configured to move in the first optical axis direction.

### CROSS-REFERENCE TO RELATED APPLICATIONS

This application claims the benefit under 35 USC § 119(a) of Korean Patent Application No. 10-2024-0057339 filed on Apr. 30, 2024, and Korean Patent Application No. 10-2024-0112239 filed on Aug. 21, 2024, in the Korean Intellectual Property Office, the entire disclosures of which are incorporated herein by reference for all purposes.

### BACKGROUND

### 1. Field

The following description relates to a camera module.

### 2. Description of Related Art

Camera modules (hereinafter, folded camera modules) including a reflective member that diverts or changes the path of incident light have been implemented in many mobile devices.

Typically, a folded camera module has a structure in which incident light passes through the reflective member and a plurality of lenses in sequence before being received by an image sensor. Therefore, the plurality of lenses are disposed in a length direction of the camera module, having less restrictions on a number of lenses.

Additionally, for folded camera modules, shake correction is implemented by rotating the reflective member, and focus adjustment is implemented by moving a portion or the entirety of the lens. In this example, a portion or entirety of the lenses may be moved in a longitudinal direction of the camera module.

Recently, the plurality of lenses may be disposed in front of reflective elements in order to make the camera module have a more compact structure. However, in this example, although a length of the camera module is decreased, a height of the camera module may be increased.

In particular, if a movement distance of the plurality of lenses is even considered, the height of the camera module becomes greater than a thickness of the mobile device, which causes a problem in that the lenses inevitably protrude outside the mobile device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a plurality of lens modules, each including one or more lenses; and a reflective module including a reflective member configured to change a path of light incident on the plurality of lens modules, wherein the plurality of lens modules and the reflective module are disposed in a first optical axis direction, and wherein one of the plurality of lens modules is configured to move in the first optical axis direction.

The plurality of lens modules may include a first lens module in which light is incident; and a second lens module disposed between the first lens module and the reflective module.

At least one of the plurality of lens modules and the reflective module may be configured to rotate about at least one or more of a first axis parallel to the first optical axis direction, a second axis perpendicular to the first axis, and a third axis perpendicular to both the first axis and the second axis.

The second lens module may be configured to rotate about at least one or more of the first axis, the second axis, and the third axis together with the reflective module.

The second lens module may be coupled to the reflective module to be spaced apart from the reflective member in the first optical axis direction.

The plurality of lens modules may be configured to move in directions parallel to a second axis and a third axis among a first axis parallel to the first optical axis direction, a second axis perpendicular to the first axis, and a third axis perpendicular to both the first axis and the second axis.

The camera module may further include a housing in which the plurality of lens modules and the reflective module are disposed, wherein the housing has a length in the first optical axis direction and a length in a second optical axis direction perpendicular to the first optical axis direction, and wherein 0.2<H/L≤1.0 is satisfied, where H is a length of the housing in a direction parallel to the first optical axis direction, and L is a length of the housing in a direction parallel to the second optical axis direction.

The reflective member may be a prism which includes an incident surface, a reflective surface, and an exit surface, and the plurality of lens modules may include one or more lenses having a diameter larger than a width of the incident surface of the prism.

In a general aspect, a camera module includes a first lens module comprising one or more lenses; a second lens module comprising one or more lenses, and being spaced apart from the first lens module in a first optical axis direction; and, a reflective module comprising a reflective member, and being spaced apart from the second lens module in the first optical axis direction, wherein one of the first lens module and the second lens module is configured to move in the first optical axis direction.

The reflective module may be configured to rotate about at least one or more of a first axis parallel to the first optical axis direction, a second axis perpendicular to the first axis, and a third axis perpendicular to both the first axis and the second axis.

The second module may be configured to rotate together with the reflective module.

The first lens module may be configured to rotate together with the second lens module and the reflective module.

The first lens module and the second lens module may be configured to rotate about at least one or more of a first axis parallel to the first optical axis direction, a second axis perpendicular to the first axis, and a third axis perpendicular to both the first axis and the second axis.

The first lens module and the second lens module may be configured to move in directions parallel to a second axis and a third axis among a first axis parallel to the first optical axis direction, a second axis perpendicular to the first axis, and a third axis perpendicular to both the first axis and the second axis.

The camera module may further include an image sensor that is spaced apart from the reflective module in a second optical axis direction perpendicular to the first optical axis direction, wherein the reflective member is configured to change a path of light from the first optical axis direction to the second optical axis direction.

The camera module may further include a third lens module comprising one or more lenses, and being spaced apart from the reflective module and the image sensor in the second optical axis direction, respectively.

Other features and aspects will be apparent from the following detailed description, the drawings, and the claims.

### BRIEF DESCRIPTION OF DRAWINGS

FIG. 1 is a configuration diagram of an example camera module, in accordance with one or more embodiments.

FIGS. 2A and 2B illustrate focus adjustment driving, in accordance with one or more embodiments.

FIGS. 3A, 3B, and 3C illustrate shake correction driving, in accordance with a first embodiment.

FIGS. 4A, 4B, and 4C illustrate shake correction driving, in accordance with a second embodiment.

FIGS. 5A, 5B, and 5C illustrate shake correction driving, in accordance with a third embodiment.

FIGS. 6A, 6B, and 6C illustrate shake correction driving, in accordance with a fourth embodiment.

FIGS. 7A and 7B illustrate shake correction driving, in accordance with a fifth embodiment.

FIG. 8 is a configuration diagram of an example camera module, in accordance with one or more embodiments.

FIG. 9 is a side view of an example mobile device that implements an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples relate to a camera module, and more specifically, to a technology for a camera module including a reflective member that changes the path of incident light.

One or more example may provide a camera module having a compact structure. In particular, the one or more example may reduce an overall length of the camera module and may minimize an increase in a height of the camera module.

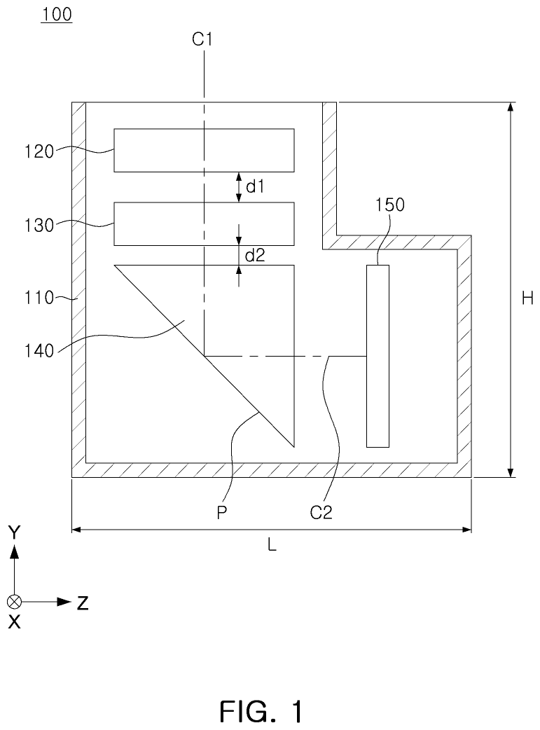

FIG. 1 is a configuration diagram of an example camera module, in accordance with one or more embodiments.

A camera module 100, in accordance with one or more embodiments, may include a housing 110, a plurality of lens modules 120 and 130, a reflective module 140, and an image sensor 150.

Referring to FIG. 1, a housing 110 may form an exterior of the camera module 100. Additionally, the housing 110 may have an internal space to accommodate a plurality of lens modules 120 and 130, a reflective module 140, and an image sensor 150. However, in an example, a portion of the lens modules disposed on an object side among a plurality of lens modules 120 and 130 may protrude outside the housing 110.

The plurality of lens modules 120 and 130 may include a first lens module 120 and a second lens module 130. The first lens module 120 and the second lens module 130 may each include one or more lenses disposed in a first optical axis (C1) direction (Y-axis direction).

The reflective module 140 may include a reflective member that changes the path of incident light. In an example, the reflective member may be provided as a prism (P) having an incident surface, a reflective surface, and an exit surface. In another example, the reflective member may be provided as a mirror instead of the prism (P).

Referring again to FIG. 1, a plurality of lens modules 120 and 130 and a reflective module 140 may be disposed in the first optical axis (C1) direction. In an example, the first lens module 120, the second lens module 130, and the reflective module 140 may be disposed sequentially in the first optical axis (C1) direction.

Additionally, the first lens module 120, the second lens module 130, and the reflective module 140 may be disposed with a gap between each of the first lens module 120, the second lens module 130, and the reflective module 140 in the first optical axis (C1) direction. The gap is disposed between each of each of the first lens module 120, the second lens module 130, and the reflective module 140 in order to secure adequate space to perform a focus adjustment drive operation and a shake correction drive operation to be described later, and to avoid collisions and interference.

The image sensor 150 may be disposed along a direction of the reflection module 140 and a second optical axis (C2). Additionally, the image sensor 150 may be disposed with a gap in the direction of the reflection module 140 and the second optical axis (C2). The gap between the image sensor 150 and the reflective module 140 may vary depending on an optical performance that the camera module 100 is intended to implement.

In other words, the reflective member (hereinafter, prism P) may change the path of incident light incident in the first optical axis (C1) direction to the second optical axis (C2) direction. The second optical axis (C2) direction may be approximately perpendicular to the first optical axis (C1) direction.

In FIG. 1, the first optical axis (C1) direction (Y-axis direction) may correspond to the height (H) of the camera module 100, and the second optical axis (C2) direction (Z-axis direction) may correspond to the length (L) of the camera module 100.

According to an embodiment, the camera module 100 may have the plurality of lens modules 120 and 130 disposed on an object side of the reflective module 140, so that the length (L) of the camera module 100 may be reduced.

In embodiments, the relationship between the length (L) of the camera module 100 and the height (H) of the camera module 100 may be expressed by the following conditional expression:

(Conditional Expression) 0.2<H/L≤1.0.

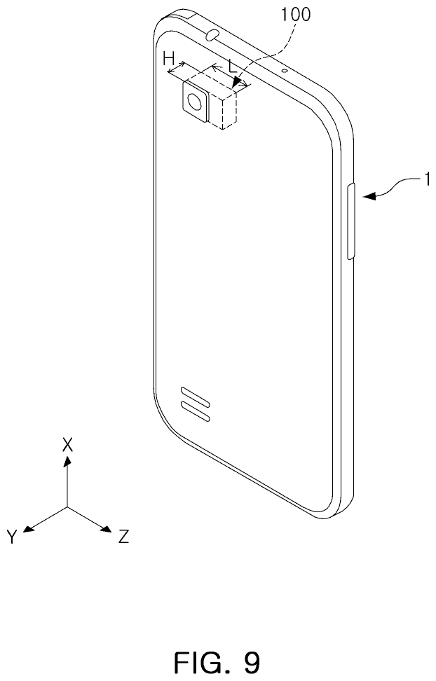

In the conditional expression, the length (L) of the camera module 100 may be a length in the second optical axis (C2) direction of the housing 110, and the height (H) of the camera module 100 may be a length in the first optical axis (C1) direction of the housing 110 (refer to FIG. 1). If the first lens module 120 protrudes outside the housing 110, the height (H) of the camera module 100 may be the length in the first optical axis (C1) direction to the protruding portion of the first lens module 120 (refer to FIG. 9).

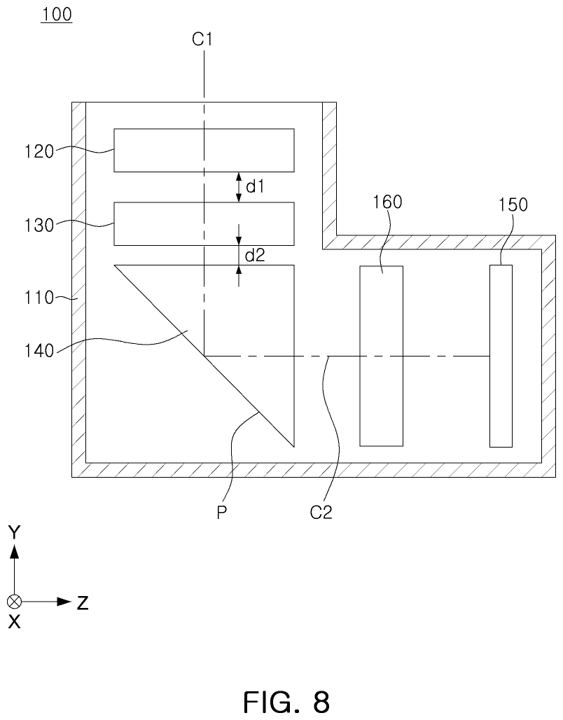

FIG. 8 is a configuration diagram of an example camera module according to another embodiment.

In another embodiment, a lens module (hereinafter, third lens module) 160 may be additionally disposed on an image side (sensor side) of the reflective module 140.

The third lens module 160 may include one or more lenses disposed in the second optical axis (C2) direction (Z-axis direction).

The third lens module 160 may be disposed between the reflective module 140 and the image sensor 150.

In an example, the reflective module 140, the third lens module 160, and the image sensor 150 may be disposed sequentially in the second optical axis (C2) direction.

Additionally, the third lens module 160 may be disposed with a gap in the direction of the reflection module (140) and the second optical axis (C2). This is to secure space for the shake correction driving described later and to avoid collisions and interference.

In an example, the third lens module 160 may be a fixed member fixedly disposed in the housing 110. Additionally, in an example, the third lens module 160 may be a movable member that rotates together with the reflective module 140 while performing shake correction of the camera module 100.

The camera module 100, in accordance with one or more embodiments, may have a focus adjustment operation and a shake correction operation.

The focus adjustment operation of the camera module 100 may be implemented by moving the first lens module 120 or the second lens module 130 in the first optical axis (C1) direction (Y-axis direction). Even if the third lens module 160 is additionally disposed, the third lens module 160 may not be involved in the focus adjustment operation of the camera module 100. That is, the third lens module 160 may be fixedly disposed in the housing 110.

The shake correction operation of the camera module 100 may be implemented by rotating (tilting) one or more of the first lens module 120, the second lens module 130, and the reflective module 140 about the first optical axis (C1), the second optical axis (C2), and one or more axes perpendicular to both the first optical axis (C1) and the second optical axis (C2).

In the following description, the first axis may be an axis perpendicular to both the first optical axis (C1) and the second optical axis (C2), which may refer to the X-axis of the drawings, a second axis may be an axis parallel to the first optical axis (C1), which may refer to the Y-axis of the drawings, and the third axis may be an axis parallel to the second optical axis (C2), which may refer to the Z-axis of the drawings. The first axis, the second axis, and the third axis may be perpendicular to each other.

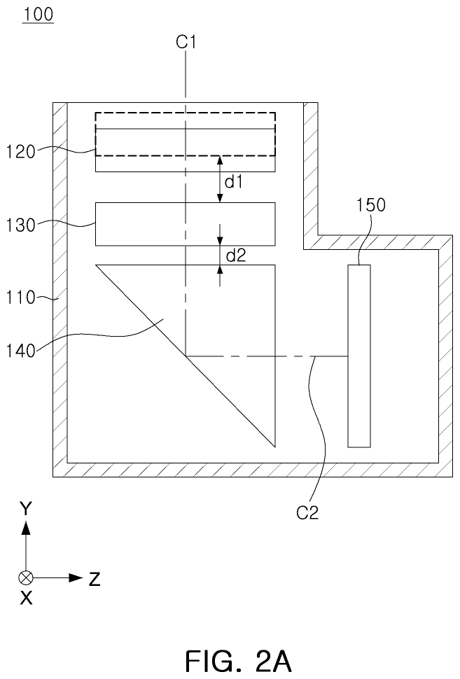

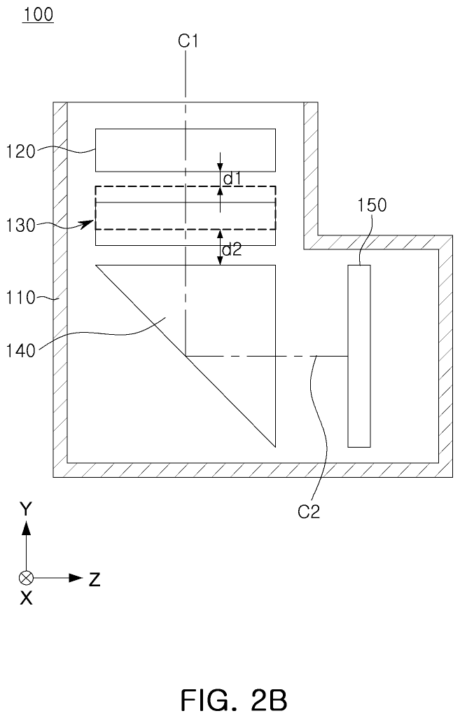

FIGS. 2A and 2B illustrate focus adjustment driving, in accordance with one or more embodiments.

In accordance with the one or more embodiments, the camera module 100 may adjust the focus by moving one of the first lens module 120 and the second lens module 130 disposed on the object side of the reflective module 140 in the first optical axis (C1) direction. The first lens module 120 or the second lens module 130 may be moved in both directions in the first optical axis (C1) direction.

In an embodiment, as illustrated in FIG. 2A, when adjusting the focus of the camera module 100, the first lens module 120 disposed most on the object side may be moved in the first optical axis (C1) direction. The first lens module 120 may be moved in the direction of the first optical axis (C1) with respect to the second lens module 130 and the reflective module 140.

As the first lens module 120 moves in the first optical axis (C1) direction, a distance (hereinafter, first distance) (d1) between the first lens module 120 and the second lens module 130 on the first optical axis (C1) may be changed (increased or decreased). In an example, when the first lens module 120 moves in the +Y direction, the first distance (d1) may increase, and when the first lens module 120 moves in the −Y direction, the first distance (d1) may decrease. In an example, a distance (hereinafter, second distance) (d2) on the first optical axis (C1) between the second lens module 130 and the reflective module 140 may be constant.

In another embodiment, as illustrated in FIG. 2B, when adjusting the focus of the camera module 100, the second lens module 130 disposed between the first lens module 120 and the reflective module 140 may be moved in the first optical axis (C1) direction.

As the second lens module 130 moves in the first optical axis (C1) direction, the first distance (d1) and the second distance (d2) may be changed (increased or decreased). For example, when the second lens module 130 moves in the +Y direction, the first distance (d1) may decrease and the second distance (d2) may increase. Conversely, when the second lens module 130 moves in the −Y direction, the first distance (d1) may increase and the second distance (d2) may decrease.

In an example, although not illustrated in drawings, the camera module 100 may include a driving portion that generates a driving force to move the first lens module 120 or the second lens module 130 in the first optical axis (C1) direction. In an example, the driving portion may be provided with a VCM actuator including a magnet and a coil. However, in an example, the driving portion may be provided with a piezoelectric element or SMA wire or the like.

Additionally, the camera module 100 may include a guide member that guides movement of the first lens module 120 or the second lens module 130 in the first optical axis (C1) direction. In an example, the guide member may be provided with a ball bearing. However, this is only an example, and in other examples, the guide member may also be provided with a spring.

According to the one or more embodiments, since only one of the first lens module 120 and the second lens module 130 moves in the first optical axis (C1) direction, the first lens module 120 and the second lens module 130 may be provided to be independently drivable. For example, the first lens module 120 and the second lens module 130 may each include a lens barrel and/or a lens holder, and the driving portion may be provided separately.

The camera module 100, in accordance with one or more embodiments, may be configured to move one of the first lens module 120 and the second lens module 130 disposed in a height (H) direction of the camera module 100 when adjusting focus, so that a moving distance of the lens module may be reduced, and thus the increase in the height (H) of the camera module 100 may be minimized.

As in the embodiments, if the lens modules disposed in front of the reflective module 140 are separated into two groups—the first lens module (120) and the second lens module (130) —and only one of them is driven when adjusting the focus, the moving distance may be reduced to approximately 300 um compared to when the entire lens module is driven.

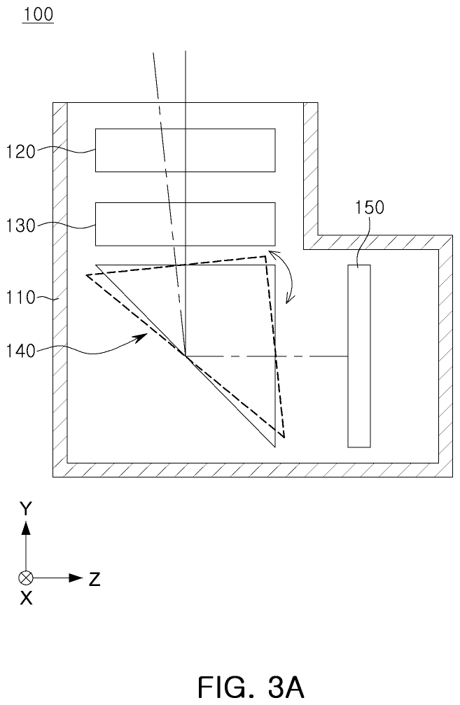

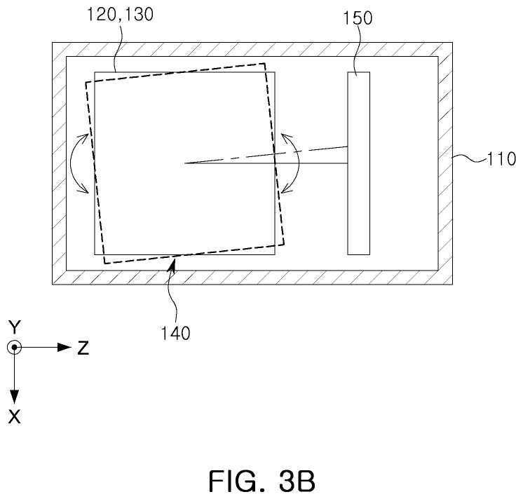

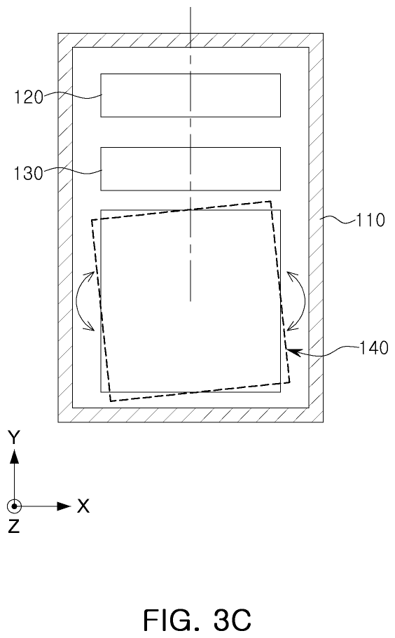

FIGS. 3A to 7B illustrate shake correction driving, in accordance with one or more embodiments.

In an accordance with the one or more embodiments, the camera module 100 may correct shaking by rotating one or more of the first lens module 120, the second lens module 130, and the reflective module 140 about one or more of the first axis (X axis), the second axis (Y axis), and the third axis (Z axis) as a rotation axis.

In an embodiment, one or more of the first lens module 120, the second lens module 130, and the reflective module 140 may be rotated about the first axis (X-axis) and the second axis (Y-axis) as rotation axes or about the first axis (X-axis) and the third axis (Z-axis) as rotation axes during shake correction.

FIGS. 3A to 3C illustrate shake correction driving, in accordance with a first embodiment.

According to the first embodiment, the reflective module 140 may be rotated when the camera module (100) is shake-corrected. The reflective module 140 may be rotated about one or more of the first axis (X-axis), the second axis (Y-axis), and the third axis (Z-axis) as a rotation axis.

FIG. 3A is an example in which the reflective module 140 is rotated about the first axis (X-axis), FIG. 3B is an example in which the reflective module 140 is rotated about the second axis (Y-axis), and FIG. 3C is an example in which the reflective module 140 is rotated about the third axis (Z-axis).

Although FIGS. 3A to 3C illustrate a state in which the reflective module 140 is rotated counterclockwise, the reflective module 140 may also be rotated in the opposite direction (clockwise).

FIG. 3B is a view of the camera module 100 when viewed from the incident-surface side of the prism (P) so that the second axis (Y-axis) rotation of the reflective module 140 is illustrated, and FIG. 3C is a view of the camera module 100 when viewed from the exit-surface side of the prism (P) so that the third axis (Z-axis) rotation of the reflective module 140 is illustrated.

In FIG. 3B, the diameters of the first lens module 120 and the second lens module 130 and the width of the incident surface of the prism (P) are illustrated as being the same. However, this is only an example, and the diameters of the first lens module 120 and the second lens module 130 and the width of the incident surface of the prism (P) may be different from each other. In an example, the diameters of a plurality of lenses included in the first lens module 120 and the second lens module 130 may be greater than the width of the incident surface of the prism (P). Additionally, the diameter of the lens included in the first lens module 120 may be greater than the diameter of the lens included in the second lens module 130. The diameter of the lens may mean an effective diameter.

The above description may be equally applied to FIG. 3C. That is, the diameters of the first lens module 120 and the second lens module 130 and the width of the exit surface of the prism (P) may be different from each other.

In an example, although not illustrated in drawings, the camera module 100 may include a driving portion that generates a driving force to rotate the reflective module 140 about one or more of the first axis (X axis), the second axis (Y axis), and the third axis (Z axis). In an example, the driving portion may be provided with a VCM actuator including a magnet and a coil. However, this is only an example, and the driving portion may be provided with a piezoelectric element or an SMA wire or the like.

Additionally, the camera module 100 may include a guide member that guides (supports) the rotation of the reflective module 140. In an example, the guide member may be provided with a ball bearing. However, the guide member may also be provided with a spring.

According to the embodiments of FIGS. 3A to 3C, one of the first lens module 120 and the second lens module 130 may be a movable member that moves when adjusting focus, and the other may be a fixed member that is fixedly disposed in the housing 110. Additionally, the reflective module 140 may be a movable member that moves during shake correction. In this example, the reflective module 140 and the first lens module 120 or second lens module 130 may be driven independently.

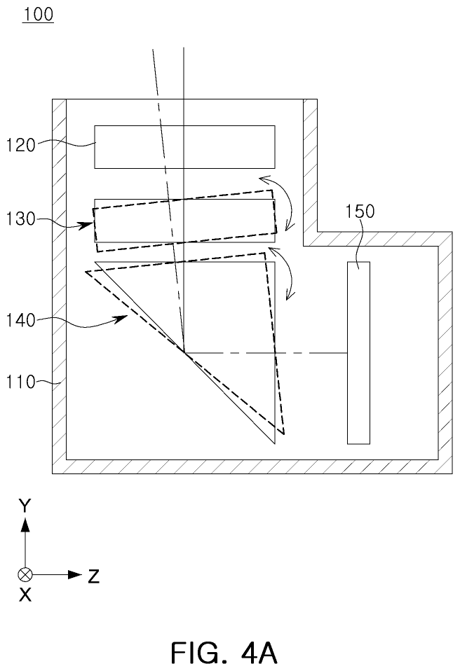

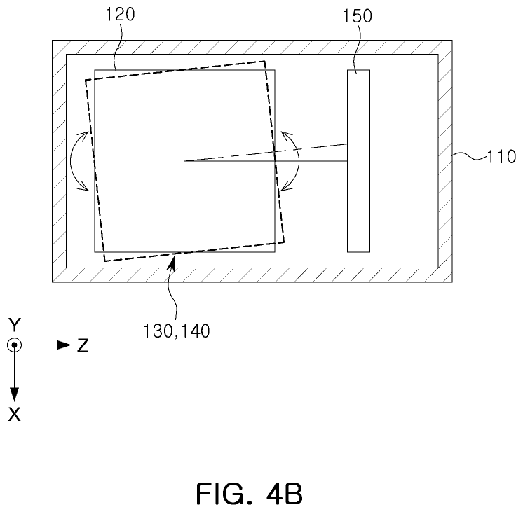

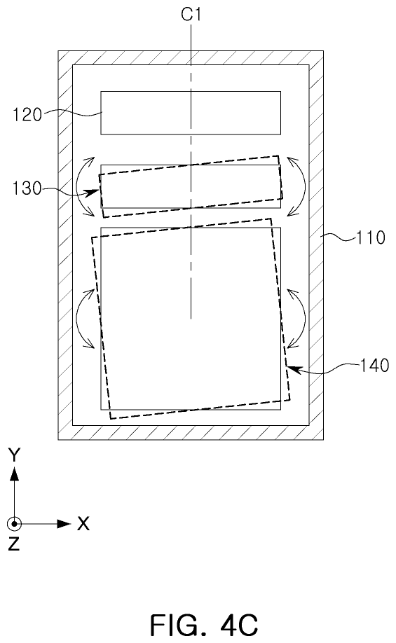

FIGS. 4A to 4C illustrate shake correction driving, in accordance with a second embodiment.

According to the second embodiment, the second lens module 130 and the reflection module 140 may be rotated to perform the shake-correction operation of the camera module (100). The second lens module 130 and the reflective module 140 may be rotated about one or more of the first axis (X-axis), the second axis (Y-axis), and the third axis (Z-axis).

According to the embodiments of FIGS. 4A to 4C, at least one of the first lens module 120 and the second lens module 130 may be a movable member.

In an example, the first lens module 120 may be a movable member that moves when adjusting the focus, and the second lens module 130 and the reflective module 140 may be movable members that move during the shake correction operation. In this example, the second lens module 130 and the reflective module 140 may be driven independently or together. In an example, the second lens module 130 may be coupled to the reflective module 140, and may rotate together with the reflective module 140 during a shake correction operation.

In another example, the first lens module 120 may be a fixed member that is fixedly disposed in the housing 110, and the second lens module 130 may be a movable member that moves during a focus adjustment operation and a shake correction operation. Additionally, the reflective module 140 may be a movable member that moves during a shake correction operation. In this example, the second lens module 130 may be driven independently from the reflective module 140.

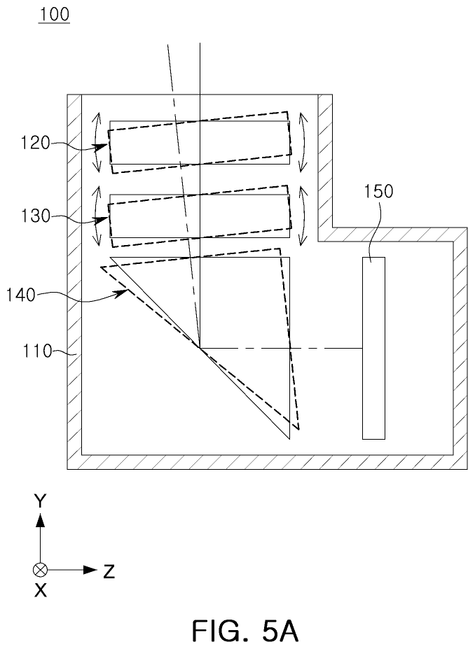

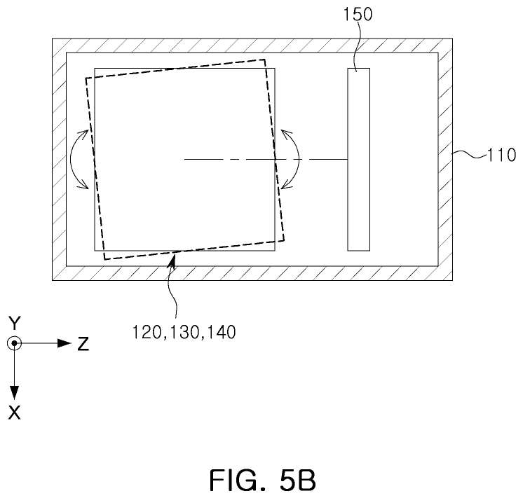

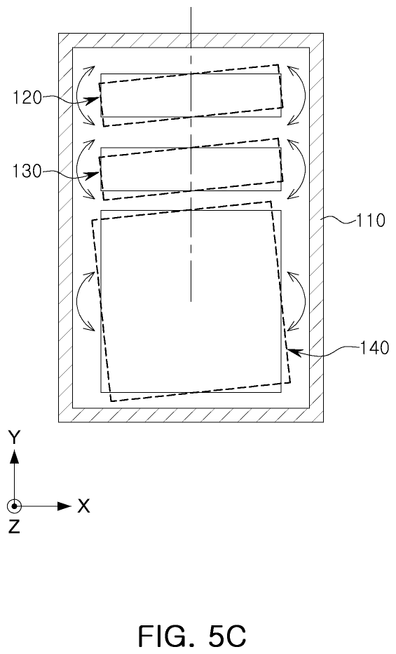

FIGS. 5A to 5C illustrate shake correction driving, in accordance with a third embodiment.

According to the third embodiment, during a shake correction operation of the camera module 100, the first lens module 120, the second lens module 130, and the reflective module 140 may all be rotated. The first lens module 120, the second lens module 130, and the reflective module 140 may be rotated about one or more of the first axis (X-axis), the second axis (Y-axis), and the third axis (Z-axis) as a rotation axis.

According to the embodiments of FIGS. 5A to 5C, the first lens module 120, the second lens module 130, and the reflective module 140 may all be movable members.

In an example, the first lens module 120 may be a movable member that moves during a focus adjustment operation and a shake correction operation, and the second lens module 130 and the reflective module 140 may be movable members that move during a shake correction operation. In this example, the second lens module 130 and the reflective module 140 may be driven independently or together. In an example, the second lens module 130 may be coupled to the reflective module 140, and may rotate together with the reflective module 140 during a shake correction operation.

In another example, the first lens module 120 and the reflective module 140 may be movable members that move during a shake correction operation, and the second lens module 130 may be a movable member that moves during a focus adjustment operation and a shake correction operation. In this example, the first lens module 120 and the second lens module 130 may be driven independently or together. In an example, the second lens module 130 may be disposed to be movable in the direction of the first optical axis (C1) on the first lens module 120, and the first lens module 120 may be disposed to be rotatable about one or more of the first axis (X-axis), the second axis (Y-axis), and the third axis (Z-axis) on the housing 110. Since the second lens module 130 may be disposed on the first lens module 120, the second lens module 130 may rotate together with the first lens module 120.

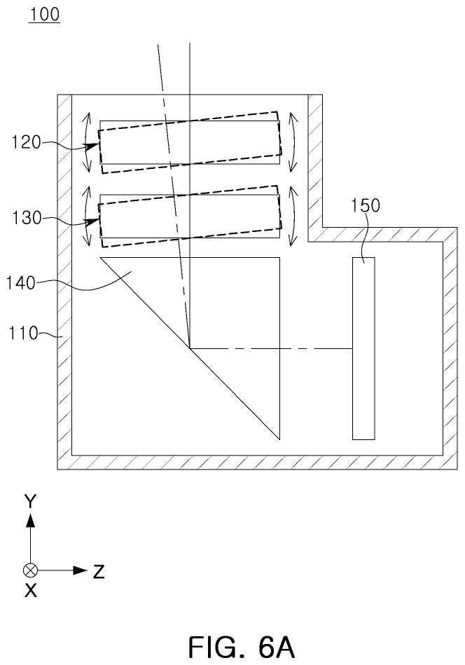

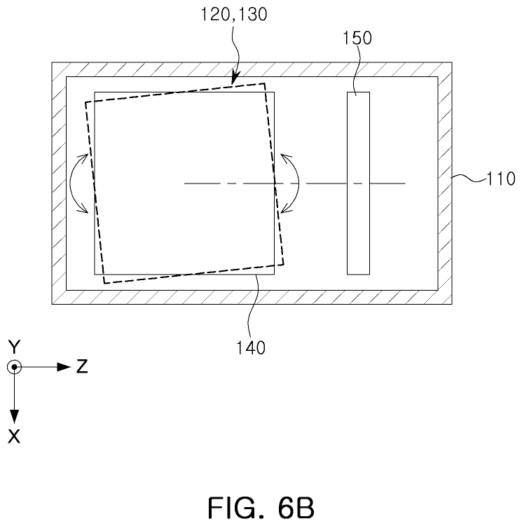

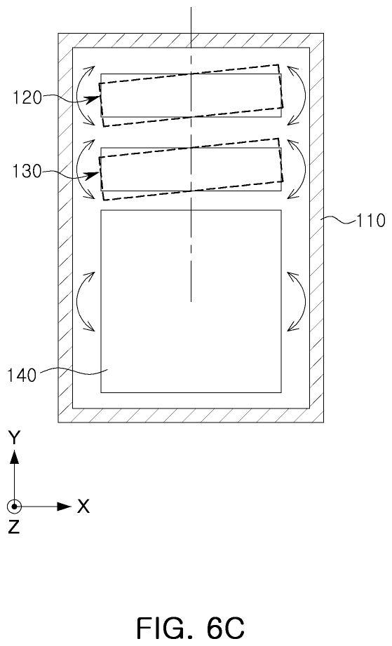

FIGS. 6A, 6B, and 6C illustrate shake correction driving, in accordance with a fourth embodiment.

According to the fourth embodiment, the first lens module 120 and the second lens module 130 may be rotated during a shake correction operation of the camera module 100. The first lens module 120 and the second lens module 130 may be rotated about one or more of the first axis (X-axis) and the third axis (Z-axis), preferably, the first axis (X-axis) and the third axis (Z-axis) as a rotation axis.

According to the embodiments of FIGS. 6A, 6B, and 6C both the first lens module 120 and the second lens module 130 may be movable members.

In an example, the first lens module 120 may be a movable member that moves during a focus adjustment operation and a shake correction operation, and the second lens module 130 may be a movable member that moves during a shake correction operation. In an example, the first lens module 120 may be a movable member that moves during a shake correction operation, and the second lens module 130 may be a movable member that moves during a focus adjustment operation and a shake correction operation.

In the fourth embodiment, the first lens module 120 and the second lens module 130 may be driven independently or together. In an example, the first lens module 120 may be disposed to be movable in the first optical axis (C1) direction on the second lens module 130, and the second lens module 130 may be disposed to be rotatable about the first axis (X-axis) and the third axis (Z-axis) on the housing 110. Since the first lens module 120 may be disposed on the second lens module 130, the first lens module 120 may rotate together with the second lens module 130. Or, conversely, the second lens module 130 may be disposed to be movable in the first optical axis (C1) direction on the first lens module 120, and the first lens module 120 may be disposed to be rotatable about the first axis (X-axis) and the third axis (Z-axis) on the housing 110. Accordingly, the second lens module 130 may be rotated together with the first lens module 120.

In an example, the reflective module 140 may be a fixed member that is fixedly disposed in the housing 110.

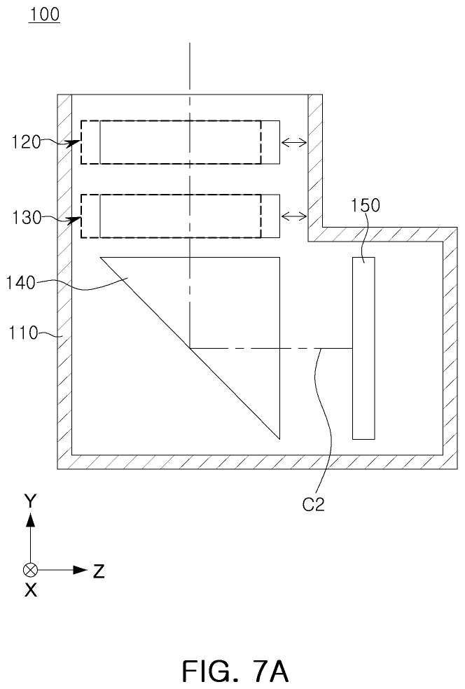

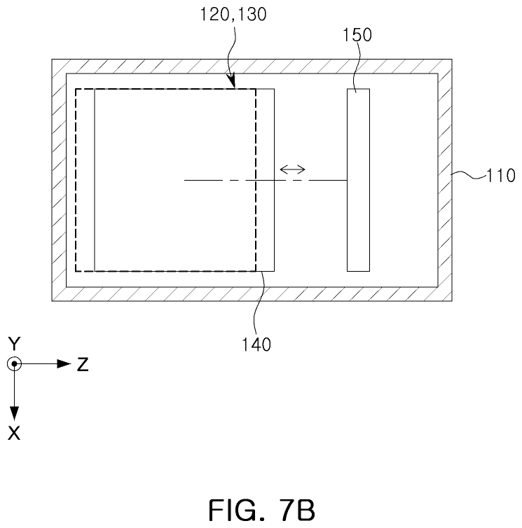

FIGS. 7A and 7B illustrate shake correction driving, in accordance with a fifth embodiment.

According to the fifth embodiment, the first lens module 120 and the second lens module 130 may be moved in a direction perpendicular to the first optical axis (C1) during a shake correction operation of the camera module 100. That is, the first lens module 120 and the second lens module 130 may be moved in the direction of one or more of the first axis (X-axis) and the third axis (Z-axis), preferably in the direction of the first axis (X-axis) and the third axis (Z-axis).

Although FIGS. 7A and 7B illustrate a state in which the first lens module 120 and the second lens module 130 are moved to the left, that is only an example, and in an example, the first lens module 120 and the second lens module 130 may be moved in the opposite direction (to the right).

In the fifth embodiment, the first lens module 120 may be disposed to be movable in the first optical axis direction (C1) on the second lens module 130, and the second lens module 130 may be disposed to be movable in the direction parallel to the first axis (X-axis) and the third axis (Z-axis) on the housing 110. Or, conversely, the second lens module 130 may be disposed to be movable in the first optical axis direction (C1) on the first lens module 120, and the first lens module 120 may be disposed to be movable in the direction parallel to the first axis (X-axis) and the third axis (Z-axis) on the housing 110. Accordingly, the first lens module 120 and the second lens module 130 may be moved together in the direction parallel to the first axis (X-axis) and the third axis (Z-axis).

In an example, the reflective module 140 may be a fixed member that is fixedly disposed in the housing 110.

In explaining the embodiments of FIGS. 4A to 7B, overlapping contents with the embodiments of FIGS. 3A to 3C have been omitted.

FIG. 9 is a side view of an example mobile device that implements a camera module according to the one or more example embodiments.

The camera module 100 according to the one or more embodiments described above may be mounted on a mobile device 1. In FIG. 9, the mobile device is illustrated in the form of a smart-phone. However, this is only an example, and the mobile device may also be mounted on other types of mobile devices such as, but not limited to, a laptop, a tablet personal computer (PC), a virtual reality (VR) device, or the like.

Referring to FIG. 9, the height direction of the camera module 100 and the thickness direction of the mobile device 1 may be parallel to the first optical axis (C1) direction. Additionally, the length direction of the camera module 100 and the width direction of the mobile device 1 may be parallel to the second optical axis (C2) direction. That is, the height (H) of the camera module 100 may correspond to the thickness of the mobile device 1, and the length (L) of the camera module 100 may correspond to the width of the mobile device 1.

According to the one or more embodiments, since the camera module 100 may have a plurality of lens modules 120 and 130, and a reflective module 140 disposed in the first optical axis (C1) direction, the length (L) of the camera module 100 may be shortened, and the camera module 100 may be manufactured compactly. Accordingly, the installation space of the camera module 100 in the mobile device 1 may be reduced.

In accordance with the one or more embodiments, since the plurality of lens modules 120 and 130, and a reflective module 140 may be disposed in the first optical axis (C1) direction, the height (H) of the camera module 100 may increase beyond the thickness of the mobile device 1, and a portion of the camera module 100 may protrude outside the mobile device 1.

However, since the camera module 100, in accordance with one or more embodiments may move one of the plurality of lens modules 120 and 130 when adjusting the focus, the range of movement of the lens module is reduced, thereby minimizing the protrusion amount of the camera module 100.

According to the one or more embodiments, the camera module may be configured compactly while maintaining optical performance, and the amount of lens protrusion may be minimized.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a plurality of lens modules, each comprising one or more lenses; and
a reflective module comprising a reflective member configured to change a path of light incident on the plurality of lens modules,
wherein the plurality of lens modules and the reflective module are disposed in a first optical axis direction, and
wherein one of the plurality of lens modules is configured to move in the first optical axis direction.

2. The camera module of claim 1, wherein the plurality of lens modules comprise:
a first lens module in which light is incident; and
a second lens module disposed between the first lens module and the reflective module.

3. The camera module of claim 2, wherein:
at least one of the plurality of lens modules and the reflective module is configured to rotate about at least one or more of a first axis parallel to the first optical axis direction, a second axis perpendicular to the first axis, and a third axis perpendicular to both the first axis and the second axis.

4. The camera module of claim 3, wherein the second lens module is configured to rotate about at least one or more of the first axis, the second axis, and the third axis together with the reflective module.

5. The camera module of claim 4, wherein the second lens module is coupled to the reflective module to be spaced apart from the reflective member in the first optical axis direction.

6. The camera module of claim 2, wherein the plurality of lens modules are configured to move in directions parallel to a second axis and a third axis among a first axis parallel to the first optical axis direction, a second axis perpendicular to the first axis, and a third axis perpendicular to both the first axis and the second axis.

7. The camera module of claim 1, further comprising:
a housing in which the plurality of lens modules and the reflective module are disposed,
wherein the housing has a length in the first optical axis direction and a length in a second optical axis direction perpendicular to the first optical axis direction, and
wherein 0.2<H/L≤1.0 is satisfied,
where H is a length of the housing in a direction parallel to the first optical axis direction, and L is a length of the housing in a direction parallel to the second optical axis direction.

8. The camera module of claim 1, wherein:
the reflective member is a prism which comprises an incident surface, a reflective surface, and an exit surface, and
the plurality of lens modules comprise one or more lenses having a diameter larger than a width of the incident surface of the prism.

9. A camera module, comprising:
a first lens module comprising one or more lenses;
a second lens module comprising one or more lenses, and being spaced apart from the first lens module in a first optical axis direction; and,
a reflective module comprising a reflective member, and being spaced apart from the second lens module in the first optical axis direction,
wherein one of the first lens module and the second lens module is configured to move in the first optical axis direction.

10. The camera module of claim 9, wherein
the reflective module is configured to rotate about at least one or more of a first axis parallel to the first optical axis direction, a second axis perpendicular to the first axis, and a third axis perpendicular to both the first axis and the second axis.

11. The camera module of claim 10, wherein the second module is configured to rotate together with the reflective module.

12. The camera module of claim 11, wherein the first lens module is configured to rotate together with the second lens module and the reflective module.

13. The camera module of claim 9, wherein the first lens module and the second lens module are configured to rotate about at least one or more of a first axis parallel to the first optical axis direction, a second axis perpendicular to the first axis, and a third axis perpendicular to both the first axis and the second axis.

14. The camera module of claim 9, wherein the first lens module and the second lens module are configured to move in directions parallel to a second axis and a third axis among a first axis parallel to the first optical axis direction, a second axis perpendicular to the first axis, and a third axis perpendicular to both the first axis and the second axis.

15. The camera module of claim 9, further comprising:
an image sensor that is spaced apart from the reflective module in a second optical axis direction perpendicular to the first optical axis direction,
wherein the reflective member is configured to change a path of light from the first optical axis direction to the second optical axis direction.

16. The camera module of claim 15, further comprising:
a third lens module comprising one or more lenses, and being spaced apart from the reflective module and the image sensor in the second optical axis direction, respectively.
